(19) United States
(12) Patent Application Publication
(10) Pub. No.: US 2009/0166268 A1
(43) Pub. Date: Jul. 2, 2009

(54) Vibrating screen having a wear protection

(75) Inventor: Mats Malmberg, Rydsgard (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 12/314,829

(22) Filed: Dec. 17, 2008

(30) Foreign Application Priority Data
Dec. 19, 2007 (SE) 0702822-8

(51) Int. Cl. B07B 1/46

(52) U.S. Cl. 209/405; 209/412

(57) ABSTRACT

The present invention concerns a vibrating screen having wear protections placed on beams of the vibrating screen. A supporting structure for screening media is placed on the beams. The wear protections are snapped onto adapters fixed to the beams. The adapters are fixed to the beams by an adhesive. The supporting structure includes support carriers fixed to transversal carriers. The transversal carriers are received in channels of the adapters.

### CROSS-REFERENCE TO PRIOR APPLICATION

This application claims priority to Swedish Application No. 0702822-8 filed Dec. 19, 2007, which is incorporated by reference herein.

### FIELD OF THE INVENTION

The present invention concerns a vibrating screen having a wear protection placed on beams of the screen.

### BACKGROUND OF THE INVENTION

In vibrating screens used for separation of, for example, crushed stones and gravel into fractions of stones with different sizes, screening media are used having screening holes for allowing stones smaller than the screening holes to pass through the screening media. The screens may have different types of screening media placed on a supporting structure, which supporting structure is connected to sidewalls of the screen in some way. Often the supporting structure rests on a number of beams fixed to the sidewalls of the screen. For present screens, transverse carriers or other parts of the supporting structure are normally welded to the beams.

The fractioned parts, such as crushed stones, will bounce during fractionation and may hit the beams. To protect the beams, they may be covered with a protective material, often some kind of polymeric material. In use, the protective cover wears down and has to be replaced from time to time.

To reduce the weight of the screen, different metallic parts have been replaced by parts of other materials, normally polymeric materials or composites, such as fiberglass. Thus, the parts of the supporting structure to be placed in contact with the beams may now be made of a non-metallic material. In one example, the supporting structure includes transversal carriers that are placed in contact with the beams.

As indicated above, the transversal carriers or other part of the supporting structure in contact with the beams are normally welded thereto. The beams normally are made of steel or other suitable metal. For transversal carriers and supporting structures made of fiberglass composite and/or other polymeric material, there is a need for another way of connecting the transversal carriers to the beams. Non-metallic parts are often fixed to metallic parts, such as beams, by means of an adhesive. However, there is a need in the art to provide a better connection between a non-metallic supporting structure and a metallic beam.

### SUMMARY

One object of the present invention is to fix non-metallic parts of a supporting structure to beams of the screen and also to attach wear protections to the beams. A further object of the present invention is that the wear protections of the beams should be relatively easy to replace.

According to the present invention, a screen is provided having wear protections surrounding the beams. The beams receive a supporting structure for screening media. The wear protections are snapped onto adapters fixed to the beams.

Further objects and advantages will be obvious for a person skilled in the art, reading the detailed description below of at present preferred embodiments.

### BRIEF DESCRIPTION OF THE DRAWINGS

The invention will be described further below, by way of examples and with reference to the enclosed drawings. In the drawings,

FIG. 1 is a perspective view of one example of a vibrating screen,

FIG. 2 is a perspective view of a support structure placed on beams of the screen,

FIG. 3 is a section of a beam of FIG. 2 illustrating mounting of a wear protection, and

FIG. 4 is a perspective view of an adapter used in the embodiment of FIG. 3.

### DETAILED DESCRIPTION OF THE PREFERRED EMBODIMENTS

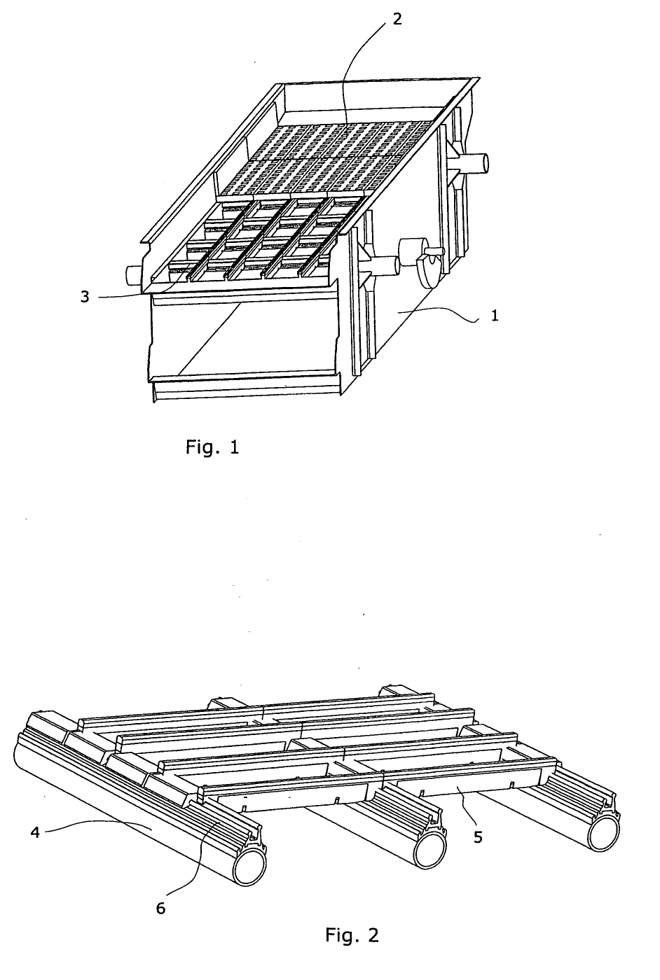

With reference to FIGS. 1 and 2, a vibrating screen 1 has a screen deck receiving materials to be screened, such as crushed stones, gravel etc. The screen deck includes screening media 2, received on a supporting structure 3. Preferably, the supporting structure 3 rests on beams 4 fixed to the sides of the screens 1. It should be understood that the exact form of the supporting structure and screening media are not importance for an understanding of the present invention. As such, they will not be described extensively here.

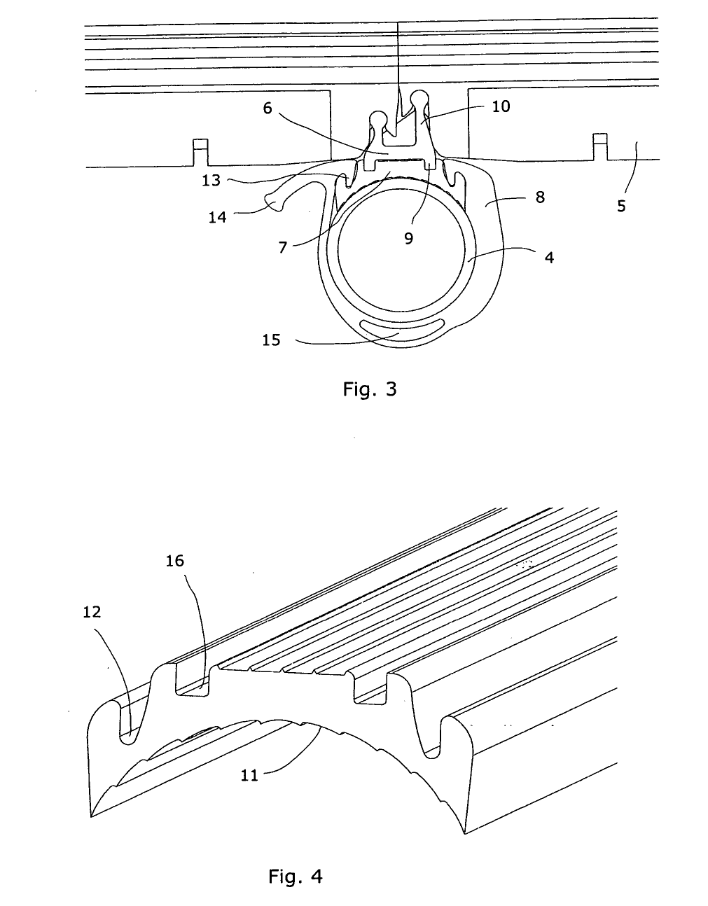

In the shown embodiment, support carriers 5 of the supporting structure 3 are fixed to transversal carriers 6. With reference to FIGS. 2 and 3, each transversal carrier 6 is fixed to a beam 4 by means of an adapter 7 placed on top of the beam 4. In this embodiment, the transversal carriers 6 are made of fiberglass and/or suitable polymeric material. The transversal carriers 6 are fixed to the adapters 7 by means of an adhesive. Furthermore, each transversal carrier 6 has two rails 9 protruding down into channels 16 of the adapter 7. The arrangement of placing the rails 9 of the transversal carriers 6 in the channels 16 of the adapters 7 will assist in keeping the transversal carriers 6 in place in relation to the beams 4. As is previously known, the transversal carriers 6 have stanchions 10 received in grooves of the support carriers 5. A person skilled in the art realizes that in other embodiments the stanchions 10 may be of equal height, all depending on the design of the vibrating screen 1.

Preferably, the adapters 7 are fixed to the beams 4 by means of an adhesive. Each adapter 7 has the form of a strip, having a length corresponding with the length of the beams 4. The adapter 7 placed at the top of one beam 4 extends a part of the circumference of the beam 4, seen in cross section as in FIG. 3. To increase the effect of the adhesive, the surface 11 of the adapter 7 facing the beam 4 may have one or more slits providing an uneven surface. It is also possible to let the contact surface between the adapter 7 and the transversal carrier 6 be uneven to enhance the effect of the adhesive. In the shown embodiment, the adapters 7 have a rounded lower surface 11 following the rounded form of the beam 4 to which the adapter 7 is to be glued. A person skilled in the art realizes that the form of the lower surface 11 should be adapted to the form of the beam receiving the adapter. Thus, if the beam has a rectangular form, the lower surface will be straight, if the beam has an oval form the lower surface will also have an oval form and so on.

A wear protection 8 is placed around each beam 4. The wear protection 8 has the form of a flexible strip and should extend the total length of the beam 4. Normally, the wear protection 8 and corresponding adapter 7 is formed of a number of segments placed with the ends abutting each other. The length of each segment of the wear protection 8 and adapter 7 is such that the parts are easy to handle at installation and possible replacement. Also the transversal carriers 6 are normally made in segments. The wear protection 8 is snapped onto the adapter 7.

With reference to FIG. 4, the edges of the adapter 7 are formed with grooves 12, giving the edges the form of hooks as seen in cross section. When placed on the beam 4, the grooves 12 at the edges of the adapter 7 will be parallel with the beam 4. The grooves 12 are to receive protruding parts 13 of the wear protection 8. Thus, the protruding parts 13 project into the grooves 12 of the adapter 7. The grooves 12 of the adapter and the protruding parts 13 of the wear protection 8 should be formed and placed in such a way that edges of the wear protection 8 will be placed on top of the adapter 7 covering the grooves 12 or hooks of the adapter 7. Preferably, the grooves 12 of the adapter 7 are open toward each other and also toward the transversal carrier 6. The positions of the grooves 12 of the adapter 7 and the protruding parts 13 of the wear protection 8 should be such that the major part of the beam 4 is covered by the wear protection 8. It is important that all parts of the beam 4 having a risk of being hit by fractioned parts should be covered if possible. The parts of the beam 4 placed just adjacent the supporting structure 3 have a much lower risk of being hit than the other parts.

At one edge, the wear protection 8 is furnished with a gripping piece 14, which may be pulled when mounting and dismounting of the wear protection 8 to and from, respectively, the adapter 7, as shown in FIG. 3. In addition, an air pocket 15 may be formed on the wear protection 8, which air pocket 15 is placed diametrically opposite the adapter 7 when the wear protection 8 has been mounted. The air pocket 15 enhances the contact between the beam 4 and the wear protection 8 and also makes mounting of the wear protection 8 easier.

The beams 4 are shown having a circular cross section, but a person skilled in the art realizes that the present invention may be used also with beams having other cross section forms, such as oval, square, rectangular and other polygonal forms.

In use, the wear protection 8 may be mounted and dismounted by hand. Normally the wear protection 8 is mounted when the support carriers 5 of the support structure 3 are removed. In mounting, the edge of the wear protection 8 not including the gripping piece 13, is first placed in one of the hook-like grooves 12 of the adapter 7. The wear protection 8 is then placed around the beam 4 whereby the other edge of the wear protection 8 including the gripping piece 13 is placed in the other groove 12 of the adapter 7.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A screen having wear protections placed on beams, on which beams a supporting structure for screening media is placed, wherein the wear protections are snapped onto adapters fixed to the beams.

2. The screen of claim 1, wherein the adapters are fixed to the beams by means of an adhesive and that parts of the supporting structure are fixed to the adapters by means of an adhesive.

3. The screen of claim 2, wherein each adapter has the form of a strip extending the total length of respective beam.

4. The screen of claim 2, wherein a surface of each adapter to be fixed to a beam is uneven.

5. The screen of claim 2, wherein the parts of the supporting structure fixed to the adapters have rails received in channels of the adapters.

6. The screen of claim 2, wherein the parts of the supporting structure fixed to the adapters are transversal carriers having stanchions on which support carriers are received.

7. The screen of claim 1, wherein the wear protections have the form of flexible strips extending the total length of the beams.

8. The screen of claim 1, wherein the adapters, the transversal carriers and/or the wear protections are made in segments.

9. The screen of claim 7, wherein the adapters have grooves at edges parallel with the beam, which edges form a hook seen in cross section and that protruding parts at the edges of the wear protections are received in the grooves of the adapters, giving a snap locking of the wear protections to the adapters.

10. The screen of claim 9, wherein the grooves of the adapters open toward each other.

11. The screen of claim 7, wherein each wear protection has an air pocket placed diametrically opposite the adapter after mounting to the beam.

12. The screen of claim 7, wherein a gripping piece is placed at one edge of the wear protections.
